(19) United States
(12) Patent Application Publication
(10) Pub. No.: US 2019/0374956 A1
(43) Pub. Date: Dec. 12, 2019

(54) PARTICLE SEPARATOR AND PARTICLE SEPARATION METHOD

(71) Applicant: SABIC GLOBAL TECHNOLOGIES B.V., Bergen op Zoom (NL)

(72) Inventor: Brian Price, Evansville, IN (US)

(21) Appl. No.: 16/476,803

(22) PCT Filed: Jan. 9, 2018
(86) PCT No.: PCT/US2018/012957

§ 371 Date: Jul. 9, 2019

Related U.S. Application Data
(60) Provisional application No. 62/444,033, filed on Jan. 9, 2017.

(51) Int. Cl. B03B 5/40

(52) U.S. Cl. CPC B03B 5/40; B03B 5/44; B03B 2005/405

(57) ABSTRACT

A particle separator is disclosed for a first fluid that includes solid particles of different sizes dispersed therein includes a flow path of the first fluid. A chamber is disposed below the first fluid flow path. The chamber includes an open upper portion adjacent to and below the first fluid flow path. A second fluid at a second density greater than the first density is disposed in the chamber. The second fluid is in contact with the first fluid flow path at the chamber open upper portion.

### BACKGROUND

Solid particles of various materials are used in a myriad of applications. To mention only a few examples, solid particles can be used as build materials in additive manufacturing processes, as fillers dispersed in a solid matrix material, as thickeners or other functional additives to liquids, or as intermediate materials in chemical or other manufacturing processes. Solid particles can be various sizes, and processes used in the preparation or collection of solid particle materials can result in populations of solid particles with a distribution of different particle sizes. In various situations, particles of different sizes are separated from population of particles having a wider distribution of particle sizes. For example, marketing practices or other factors such as target particle size requirements for various applications can be factors that promote the separation of solid particles by size.

### BRIEF DESCRIPTION

In some embodiments, a particle separator for a first fluid that includes solid particles of different sizes dispersed therein includes a flow path of the first fluid. A chamber is disposed below the first fluid flow path. The chamber includes an open upper portion adjacent to and below the first fluid flow path. A second fluid at a second density greater than the first density is disposed in the chamber. The second fluid is in contact with the first fluid flow path at the chamber open upper portion.

In some embodiments, a method of separating particles of different sizes includes flowing a first fluid at a first density and that includes solid particles of different sizes across an upper surface of a second fluid disposed in a chamber. The second fluid is at a second density greater than the first density. According to the method, particles of a first size distribution are transferred from the first fluid to the second fluid. Particles of a second size distribution are left in the first fluid.

The above described and other features are exemplified by the following figures and detailed description.

### BRIEF DESCRIPTION OF THE DRAWINGS

The following figures are exemplary embodiments wherein the like elements are numbered alike.

FIG. 1 shows an example embodiment of a particle separator in a side view.

FIG. 2 shows another example embodiment of a multi-chamber particle separator in a side view.

FIG. 3 shows another example embodiment of a multi-chamber particle separator in a side view.

FIG. 4 shows the example embodiment of FIG. 3 in a top view.

FIG. 5 shows the example embodiment of FIG. 3 in an oblique view.

FIG. 6 shows another example embodiment of a multi-chamber separator.

### DETAILED DESCRIPTION

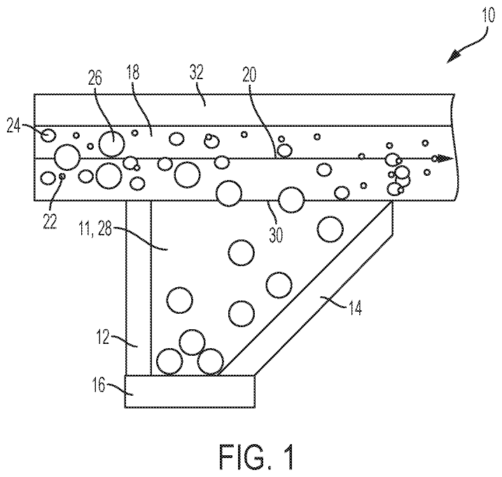

With reference to the Figures, FIG. 1 shows an example embodiment of a particle separator 10. As shown in FIG. 1, the particle size separator 10 includes a chamber 11 that can be formed as shown in FIG. 1 by a front wall 12, a back wall 14, and a bottom wall 16. A first fluid 18 at a first density is shown disposed along a first fluid flow path represented by an arrow 20. Particles of different sizes are shown dispersed in the first fluid 18, as shown by a number of small particles 22, a number of medium particles 24, and a number of large particles 26. A second fluid 28 at a second density greater than the first density is shown disposed in the chamber formed by the front wall 12, the back wall 14, and the bottom wall 16. As further shown in FIG. 1, the second fluid 28 in the chamber is disposed below and adjacent to the first fluid path through an open upper portion of the chamber 11 along a fluid boundary 30.

The particle separator 10 is shown in FIG. 1 in an operational state in which the first fluid 18 with the particles of different sizes dispersed therein flows along the first fluid flow path in the direction of the arrow 20 bounded by an upper gas space 32 and the fluid boundary 30. In accordance with Stokes' law, larger particles in a fluid under the force of gravity can achieve a higher terminal velocity than smaller particles as negative buoyancy of the particles in the fluid overcomes frictional forces that resist movement of the particles through the fluid. Accordingly, as the particle-laden first fluid 18 moves horizontally along first fluid flow path in the direction of the arrow 20 over the period of time that it takes the fluid to move across the open portion of the chamber 11 represented by the fluid boundary 30, the large particles 26 will tend to settle downward under the force of gravity faster than the medium particles 24 and the small particles 22. This results in the large particles 26 crossing the fluid boundary 30 into the second fluid 28 while the medium particles 24 and the small particles 22 are carried along on the first fluid flow path. The large particles 26, having been separated from the small particles 22 and the medium particles 24, continue settling to the bottom of the chamber at bottom wall 16 where they can be collected.

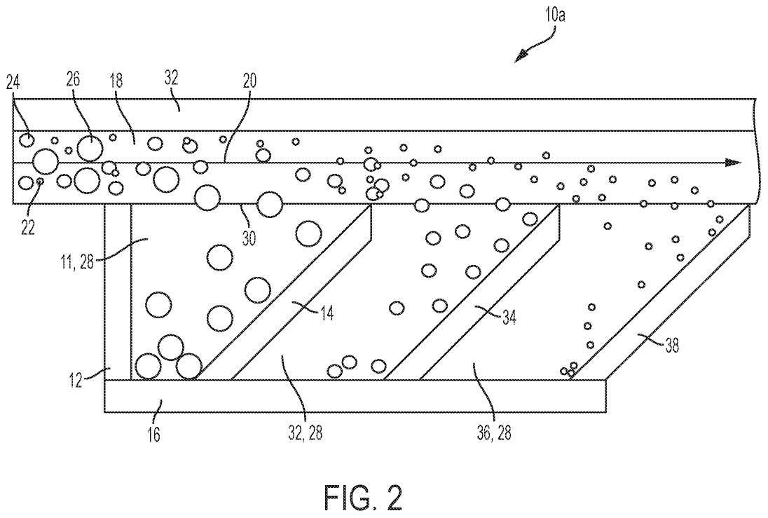

In some embodiments, the particle separator can include a plurality of chambers arranged in series adjacent to and along the first fluid flow path represented by the arrow 20. An example embodiment of a particle separator 10a that includes a plurality of chambers is shown in FIG. 2. As shown in FIG. 2, the particle separator 10a includes a first chamber 11 formed by the front wall 12, the back wall 14, and the bottom wall 16, a second chamber 32 formed by the back wall 14 (serving as a front wall for the second chamber), a wall 34, and the bottom wall 16, and a third chamber 36 formed by the wall 34, a wall 38, and the bottom wall 16. In accordance with Stokes' law, the large particles 26 have a higher terminal velocity acting under the force of gravity than the medium particles 24, which have a higher terminal velocity than the small particles 22. The higher terminal velocity of the large particles 26 causes them to settle downward under the force of gravity into the first chamber over the time it takes the first fluid 18 to move over the space above the first chamber. Over the longer period of time it takes the first fluid 18 to move past the space above the first chamber and over the space above the second chamber, the lower terminal velocity of the medium particles 24 causes them to settle downward under the force of gravity into the second chamber. Over the even longer period of time it takes the first fluid 18 to move past the space above the first and second chambers and over the space above the third chamber, the even lower terminal velocity of the small particles 22 causes them to settle downward under the force of gravity into the third chamber.

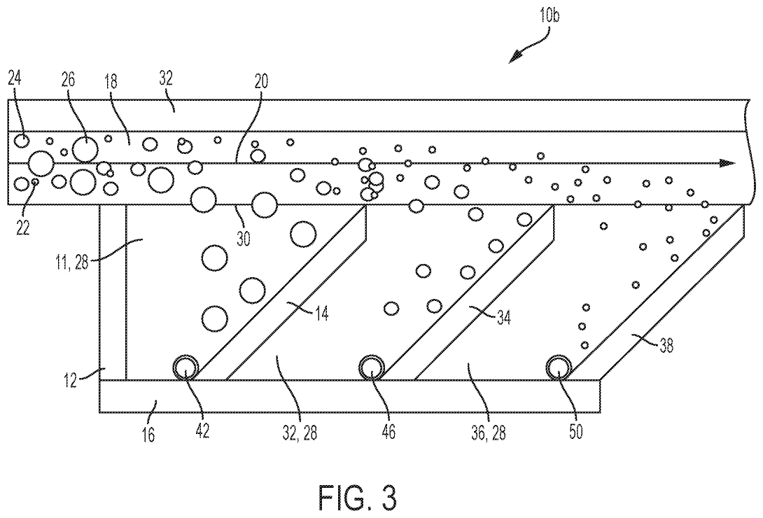

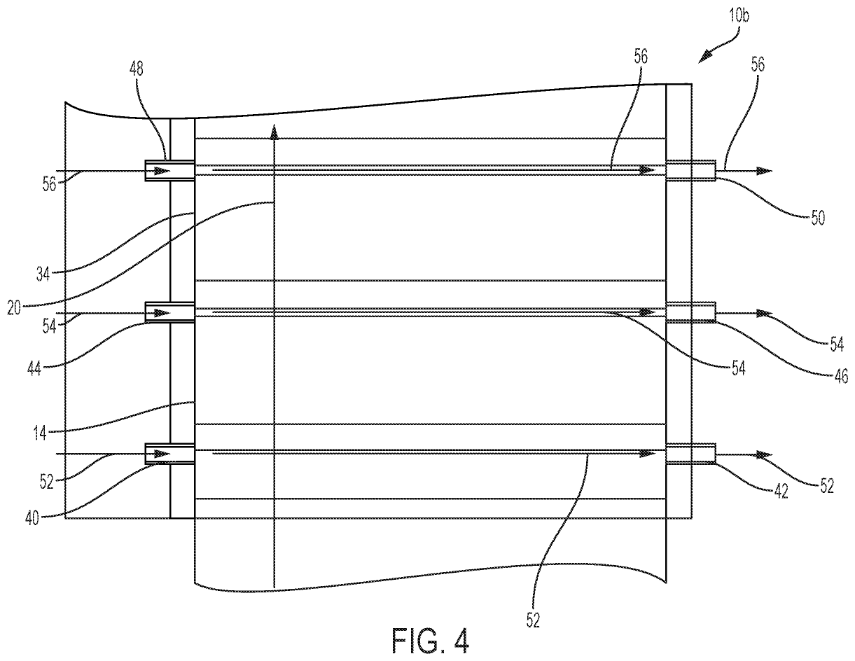

The example embodiments depicted in FIGS. 1 and 2 can provide for accumulation of size-separated particles in the chambers of the particle separator, which allows for operation in batch or semi-batch modes. In some embodiments, the chambers can be equipped with outlets or both outlets and inlets and outlets as shown in FIGS. 3 and 4. Such outlets, or inlets, or both outlets and inlets can in some embodiments allow for removal of particles or fluid, removal of both particles and fluid, removal and replenishment of fluid, circulation of fluid, or any combination thereof (e.g., circulation of fluid and with removal of particles from the circulating fluid) from the chambers before, during or after continuous, semi-batch, or batch modes of operation. As shown in the FIG. 3 side view and the FIG. 4 top view, the first chamber 11 is equipped with an inlet 40 and an outlet 42, the second chamber 32 is equipped with an inlet 44 and an outlet 46, and the third chamber 36 is equipped with an inlet 48 and an outlet 50. In some embodiments, the inlet and outlet can be operated together to provide a flow path represented by the arrows 52 through the chamber 11, or a flow path represented by the arrows 54 through the chamber 32, or a flow path represented by arrows 56 through the chamber 36, or all of these flow paths through the chambers, or any combination of flow paths through the chambers. In some embodiments, as shown in FIGS. 3 and 4, the directions of the flow paths 52, 54, 56 through the chambers can be transverse to the direction of first fluid flow path 20. In some embodiments, as shown in FIGS. 3 and 4, the flow paths 52, 54, 56 through the chambers can be located proximate to the bottom of the chambers 11, 32, 36.

As mentioned above, a particle size-based differential in downward velocity of the particles according to Stokes' law as they settle under the force of gravity out of the first fluid 18 as it moves along the flow path in the direction of arrow 20 can provide particle size-based particle separation of the particles horizontally along the direction of the first fluid flow path. The particle separator embodiments disclosed herein can in some embodiments provide a technical effect that addresses problems encountered by prior art separators that rely on counter-flow arrangements where an upward-flowing fluid carries small particles with it while larger particles settle downwards. However, the particles moving in opposite directions in such particles can interact with one another such that the downward-moving large particles interfere with upward-moving small particles and carry them downward, thus decreasing the effectiveness of the particle size separation. The particle separator embodiments disclosed herein can address this problem by keeping all particles moving in the same general direction downward while relying on a size-based velocity differential for particle separation.

In some embodiments, the effectiveness of the particle separation disclosed herein can be promoted by the avoidance or minimization of vortexes or other fluid currents in the first fluid 18 that could interfere with the particle size-dependent downward velocity resulting from the force of gravity. In some embodiments, the system can be designed and operated with the first fluid at a Reynolds number of less than or equal to 50. In some embodiments, the system can be designed and operated with the first fluid at a Reynolds number of less than or equal to 30. In some embodiments, the system can be designed and operated with the first fluid at a Reynolds number of less than or equal to 20. In some embodiments, the system can be designed and operated with the first fluid at a Reynolds number of less than or equal to 10. The Reynolds number is defined by the equation Re=ρvL/μ, where ρ represents density of the fluid, v represents a characteristic velocity of the fluid with respect to an object in the fluid, L represents a characteristic length in the first fluid, which in this case can be the width of the channel through which the first fluid is flowing, and μ represents the dynamic viscosity of the fluid. Thus the Reynolds number of the first fluid during operation can be controlled by system design parameters of any objects or surfaces of apparatus components in contact with the flowing fluid, the operational fluid velocity (which can in turn depend on the dynamic pressure of the fluid and the design parameter of the cross-sectional area of fluid flow passages), and selection of fluid materials for density and dynamic viscosity properties.

Several potential sources of flow instabilities and velocity field variations can be taken into considerations in the design and operation of the separator. One stability consideration for fluid is simply the channel flow instability which can occur at Re>1000. Another stability consideration is a shear-driven instability in which the moving first fluid drives an instability growth in the second dense fluid. In some embodiments, this second instability can be managed by use of slanted walls, such as the angle of the back walls 14, 34, 38, which are shown forming an acute angle with the direction of the first fluid flow path 20. Another consideration is the velocity field itself. Any variation of velocity, even if stable, can impact the effectiveness of size-based separation of the particles.

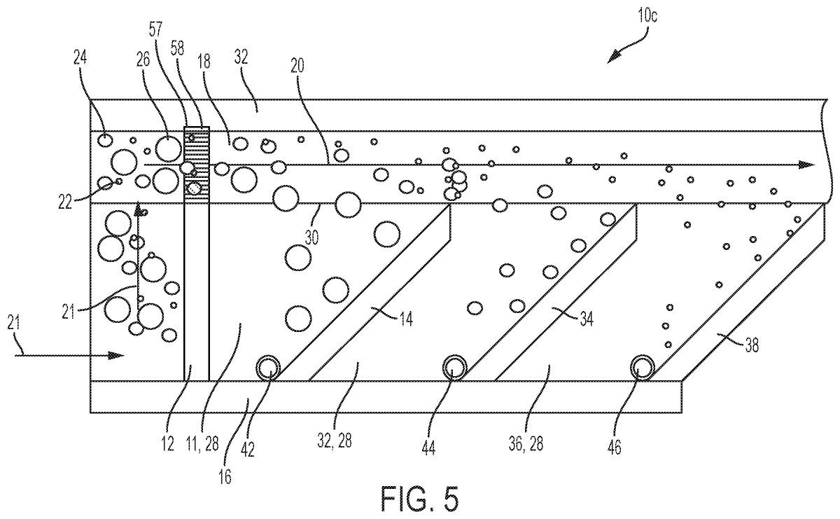

In some embodiments, structural design features of the particle separator can impact the Reynolds number and other flow characteristics. For example, as shown in FIG. 5, the flow path of the first fluid 18 in the direction of arrows 20 can approach the front wall 12 proximate to the bottom, necessitating a vertical rise over the front wall 12, shown by flow direction arrows 21, before proceeding horizontally over the second fluid 28 disposed in the chambers 11, 32, and 36. In some embodiments, this redirection of the first fluid flow path can reduce fluid velocity and disrupt eddy currents that may have formed during pumping or transportation of the fluid to the particle separator. In some embodiments, a flow guide can be disposed along the first fluid flow path to reduce eddy currents. For example, as shown in FIG. 5, a flow guide 57 can be disposed along the first fluid flow path, including baffles 58 disposed along and parallel to the direction of the first fluid flow path. Of course, these are merely examples of techniques and components for reducing eddy currents, and other design features can be used as well. Additionally, it should be noted that although FIG. 5 shows both the redirected flow path for the first fluid (arrows 21) and the flow guide 57, these features and any other features can be employed independently of one another or in combination.

As mentioned above, fluid properties such as density and dynamic viscosity can impact the fluid flow properties utilized to obtain separation of particles by size. Of course, the fluids should have a lower density than the particles so that the particles settle downward instead of rising in the fluid. In some embodiments, the first and second fluids can be liquid. In some embodiments, the first and second fluids can be gases. In some embodiments, the first fluid can be a gas and the second fluid can be a liquid. In some embodiments where the first fluid is a gas, the particle sizes can be smaller than for embodiments in which the first fluid is a liquid, due to the impact of factors such as fluid density and viscosity on the downward velocity of the particles in the flowing first fluid. In some embodiments where the first and second fluids are liquids, the liquids can be miscible with each other. In some embodiments where the first and second fluids are liquids, the liquids can be immiscible with each other, although some care may need to be taken to avoid surface active effects at the fluid boundary 30 that could interfere with the particles' downward path from the first fluid into the second fluid. As mentioned above, the second fluid has a higher density than the first fluid. In some embodiments, this density differential can promote horizontal flow of the first fluid, and help avoid downward migration of the first fluid into the chambers that could disrupt the gravity-based downward settling of the particles, the velocity of which is particle size dependent according to Stokes' law. In some embodiments, the fluids can include individual compounds (e.g., one fluid could be water and another could be an alcohol) or they can be compositions that include mixtures of different compounds. In some embodiments, the densities of the fluids can be manipulated by including a solute (e.g., a dissolved salt in water or a polar solvent). In some embodiments that include a plurality of chambers disposed adjacent to and below the first fluid flow path, the same fluid can be used in each of the chambers as the second fluid at a density greater than the first fluid. In some embodiments that include a plurality of chambers disposed adjacent to and below the first fluid flow path, different fluids (e.g., differing by composition) can be used in different chambers as the ‘second’ fluid at a density greater than the first fluid. For example, since smaller particles settle more slowly in a fluid according to Stokes' law, downstream chambers that will receive smaller particles can in some embodiments include a higher density ‘second’ fluid (compared to the density of the second fluid in upstream chambers that will receive larger particles), which in some embodiments can help promote more rapid settling rates for the smaller particles in the downstream chambers.

As mentioned above, operating parameters (e.g., first fluid flow velocity), design parameters (e.g., selection of fluids and their properties, length of the chambers along the direction of the first fluid flow path) can be selected to provide target downward velocities of different size particles for horizontal differentiation of which chambers the particles settle into along the horizontally-flowing first fluid flow path. Downward settling velocity of a particle under Stokes' law is provided by the formula: V=2R²(ρ_{particle}−ρ_{fluid})g/9μ where V represents the downward velocity of the particle under the force of gravity, R represents the radius of the particle, ρ_{particle} represents the density of the particle, ρ_{fluid}) represents the density of the fluid, g represents gravitational acceleration, and μ represents the dynamic viscosity of the fluid. With appropriate selection of operating and design parameters such as fluid selection and flow velocity, and spacing of the chambers along the first fluid flow path, a wide range of particle size ranges can be separated by particle size. In some embodiments, the particles to be separated by size can be sized in the range of 0.1-1000 μm. In some embodiments, the particles to be separated by size can be sized in the range of 0.1-100 μm. In some embodiments, the particles to be separated by size can be sized in the range of 1-100 μm.

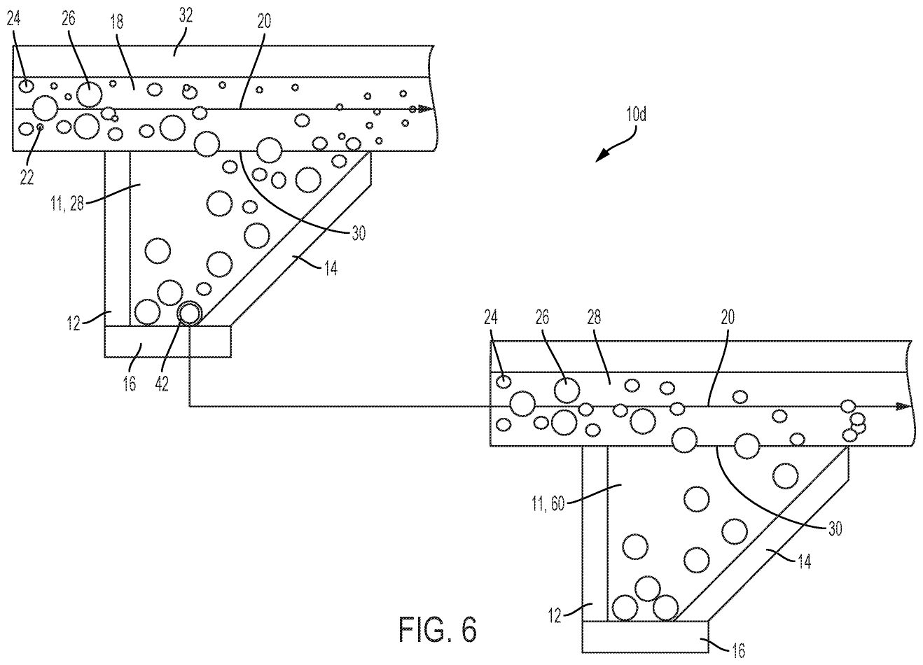

In some embodiments, resolution of the particle size separation can be promoted by multiple passes of particles through separation chambers. For example, each fraction from any chamber of a separator may also be further resolved by passing the fraction again through the either an identical separator, or a similar one operated to better resolve a particular size fraction, thus multiplying the resolution function of each individual component separator. FIG. 6 shows an example embodiment in which the medium particles small particles 22 are retained with the first fluid 18 from a first chamber separator while the medium particles 24 and large particles 26 are removed from the chamber with the fluid 28, which is used as the first fluid in a downstream chamber containing a higher density fluid 60 for separation of the medium particles 24 from the large particles 26.

This disclosure further includes the following numbered embodiments.

Embodiment 1. A particle separator (10, 10a, 10b, 10c) for a first fluid (18) that includes solid particles (22, 24, 26) of different sizes dispersed therein, comprising:
a flow path (20) of the first fluid;
a chamber (11, 32, 36) below the first fluid flow path, comprising an open upper portion (30) adjacent to and below the first fluid flow path; and
a second fluid (28) at a second density greater than the first density disposed in the chamber, the second fluid in contact with the first fluid flow path at the chamber open upper portion.

Embodiment 2. The particle separator of embodiment 1, comprising a plurality of chambers (11, 32, 26) comprising an open upper portion and fluid at a density higher than the second density in contact with the first fluid flow path at the chamber open upper portion.

Embodiment 3. The particle separator of embodiment 2, wherein at least two of the plurality of chambers comprises the second fluid.

Embodiment 4. The particle separator of embodiment 2, wherein each of the plurality of chambers comprises the second fluid.

Embodiment 5. The particle separator of embodiment 2, wherein at least one of the plurality of chambers comprises a fluid different than the second fluid.

Embodiment 6. The particle separator of embodiment 1, comprising a plurality of chambers comprising an open upper portion and fluid, arranged in series wherein the first fluid flow path of each chamber in the series is fed by fluid from an adjacent upstream chamber in the series.

Embodiment 7. The particle separator of any of embodiments 1-6, wherein each of the fluids is a liquid.

Embodiment 8. The particle separator of any of embodiments 1-7, wherein the chamber or chambers comprise an inlet (40, 44, 48), an outlet (42, 46, 50), and a flow path (52, 54, 56) between the inlet and outlet that is transverse to the first fluid flow path (20).

Embodiment 9. The particle separator of embodiment 8, wherein the inlet and outlet are disposed proximate to the bottom (16) of the chamber or chambers.

Embodiment 10. The particle separator of any of embodiments 1-9, wherein the chamber or chambers comprise a sidewall surface disposed on a side of the chamber that is downstream with respect to the first fluid flow path and at an acute angle to the first fluid flow path.

Embodiment 11. The particle separator of any of embodiments 1-10, comprising a baffle (56, 58) disposed along and parallel with the first fluid flow path.

Embodiment 12. A method of separating particles (22, 24, 26) of different sizes, comprising
flowing a first fluid (18) at a first density and that includes the solid particles of different sizes along a flow path (20) across an upper surface (30) of a second fluid (28) disposed in a chamber (11, 32, 36), said second fluid at a second density greater than the first density; and
transferring particles of a first size distribution from the first fluid to the second fluid, leaving particles of a second size distribution in the first fluid.

Embodiment 13. The method of embodiment 12, comprising flowing the first fluid at a Reynolds number of less than or equal to 10.

Embodiment 14. The method of embodiments 12 or 13, comprising flowing the first fluid through a baffle (56, 58) disposed along and parallel with the first fluid flow path.

Embodiment 15. The method of any of embodiments 12-14, comprising flowing a first fluid at a first density across upper surfaces of the second fluid or other fluid at a density greater than the first fluid density disposed in a plurality of chambers (11, 32, 36).

Embodiment 16. The method of embodiment 15, wherein each of the plurality of chambers comprises the second fluid.

Embodiment 17. The method of embodiment 15, wherein at least one of the plurality of chambers comprises a fluid different than the second fluid.

Embodiment 18. The method of any of embodiments 11-17, wherein each of the fluids is a liquid.

Embodiment 19. The method of any of embodiments 11-18, further comprising flowing the second fluid or other fluid at a density greater than the first density through the chamber or chambers along a flow path (52, 54, 56) that is transverse to the first fluid flow path.

Embodiment 20. The method of embodiment 19, wherein the second or other fluid flow path is disposed proximate to the bottom (16) of the chamber or chambers.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. The terms “upper”, “lower”, “above”, “below”, “top”, and “bottom” are used to indicate relative positions with respect to a downward vector of the force of gravity. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A particle separator for a first fluid that includes solid particles of different sizes dispersed therein, comprising:
a flow path of the first fluid;
a chamber below the first fluid flow path, comprising an open upper portion adjacent to and below the first fluid flow path; and
a second fluid at a second density greater than the first density disposed in the chamber, the second fluid in contact with the first fluid flow path at the chamber open upper portion
wherein the chamber or chambers comprise an inlet, an outlet, and a flow path between the inlet and outlet that is transverse to the first fluid flow path.

2. The particle separator of claim 1, comprising a plurality of chambers comprising an open upper portion and fluid at a density higher than the second density in contact with the first fluid flow path at the chamber open upper portion.

3. The particle separator of claim 2, wherein at least two of the plurality of chambers comprises the second fluid.

4. The particle separator of claim 2, wherein each of the plurality of chambers comprises the second fluid.

5. The particle separator of claim 2, wherein at least one of the plurality of chambers comprises a fluid different than the second fluid.

6. The particle separator of claim 1, comprising a plurality of chambers comprising an open upper portion and fluid, arranged in series wherein the first fluid flow path of each chamber in the series is fed by fluid from an adjacent upstream chamber in the series.

7. The particle separator of claim 1, wherein each of the fluids is a liquid.

8. (canceled)

9. The particle separator of claim 8, wherein the inlet and outlet are disposed proximate to the bottom of the chamber or chambers.

10. The particle separator of claim 1, wherein the chamber or chambers comprise a sidewall surface disposed on a side of the chamber that is downstream with respect to the first fluid flow path and at an acute angle to the first fluid flow path.

11. The particle separator of claim 1, comprising a baffle disposed along and parallel with the first fluid flow path.

12. A method of separating particles of different sizes, comprising
flowing a first fluid at a first density and that includes the solid particles of different sizes across an upper surface of a second fluid disposed in a chamber, said second fluid at a second density greater than the first density;
flowing the second fluid or other fluid at a density greater than the first density through the chamber or chambers along a flow path that is transverse to the first fluid flow path; and
transferring particles of a first size distribution from the first fluid to the second fluid, leaving particles of a second size distribution in the first fluid.

13. The method of claim 12, comprising flowing the first fluid at a Reynolds number of less than or equal to 10.

14. The method of claim 12, comprising flowing the first fluid through a baffle disposed along and parallel with the first fluid flow path.

15. The method of claim 12, comprising flowing a first fluid at a first density across upper surfaces of the second fluid or other fluid at a density greater than the first fluid density disposed in a plurality of chambers.

16. The method of claim 15 wherein each of the plurality of chambers comprises the second fluid.

17. The method of claim 15 wherein at least one of the plurality of chambers comprises a fluid different than the second fluid.

18. The method of claim 11, wherein each of the fluids is a liquid.

19. (canceled)

20. The method of claim 19, wherein the second or other fluid flow path is disposed proximate to the bottom of the chamber or chambers.
